(19) United States
(12) Patent Application Publication
(10) Pub. No.: US 2023/0331185 A1
(43) Pub. Date: Oct. 19, 2023

(54) Seat Belt Holding Strap for Child Car Seat

(71) Applicant: Laurie Flaherty, East Bridgewater, MA (US)

(72) Inventor: Laurie Flaherty, East Bridgewater, MA (US)

(21) Appl. No.: 17/942,147

(22) Filed: Sep. 11, 2022

Related U.S. Application Data
(63) Continuation of application No. 63/251,899, filed on Oct. 4, 2021.

(51) Int. Cl. B60R 22/10

(52) U.S. Cl. CPC B60R 22/105

(57) ABSTRACT

A harness retainer utilized for a child's car seat is disclosed. The harness retainer includes an elongated fabric portion including a magnet positioned interior to the fabric and located proximally to the middle of the elongated fabric strip. Velcro attachment points on the ends of the fabric strip allow for a seat harness to be retained to the sides of the seat or forward of where a child would be positioned in the seat.

### CROSS-REFERENCE TO RELATED APPLICATIONS

This application is a continuing application claiming the benefit of U.S. Provisional Application No. 63/251,899 filed 4 Oct. 2021.

### 1. BACKGROUND

Placing a child into a car seat can be a cumbersome task. All too often, when the infant is placed into the seat, the straps attached to the car seat that harness the child to the car seat are hard to reach, hard to hold, or positioned behind the seated infant, making it difficult to secure the child in the seat. This results in additional time needed to find the strap and buckle the child into the seat. During this time, the child may become impatient or uncomfortable. Further, such action may be in a crowded parking lot or under inclement weather, which makes the prolonged duration of the process uncomfortable for both parent and child.

### 2. OBJECTS AND BRIEF SUMMARY OF THE INVENTION

In one exemplary embodiment, the present subject disclosure is a harness retainer utilized with a child seat. The harness retainer includes an elongated fabric portion including a magnet positioned interior to the fabric and located proximally to the middle of the elongated fabric strip. Velcro attachment points on the ends of the fabric strip allow for a seat harness to be retained to the sides of the seat and out of the way while a child is secured in the seat.

In another exemplary embodiment, the present subject disclosure is a buckle retainer directed towards the magnetic buckle receiver of a child seat. The harness retainer includes an elongated fabric portion including a magnet positioned interior to the fabric and located proximally to the end of the elongated fabric strip. Velcro attachment points on the ends of the fabric strip allow for magnetic buckle to be retained to a position forward of where a child would be positioned in the seat.

In both embodiments the seat belt holding strap can be easily engaged the disengaged for utilization of the straps of the car seat and can remain in place while not in use. It is contemplated that both embodiments will be utilized concurrently.

While various aspects, features, or advantages of the subject disclosure are illustrated in reference vehicle seat harness retainers, such aspects and features also can be exploited in various other configurations.

### 3. BRIEF DESCRIPTION OF THE DRAWINGS

The foregoing and other objects, features, and advantages of the invention are apparent from the following detailed description taken in conjunction with the accompanying drawings in which:

FIGS. 1A and 1B illustrates a front and back view of the seat belt holding strap of the present invention;

FIGS. 2A and 2B illustrates an alternative embodiment of the seat belt holding strap illustrating alternative locations for the magnet and hook/loop “VELCRO” fabric in accordance with the present invention;

FIG. 3 illustrates the seat belt holding strap utilized to secure left and right seat belt buckles to the child seat carrying arm, the right strap holding strap in a position just prior to being secured.

FIG. 4 illustrates the seat belt holding strap of FIG. 3 with the right strap holding strap in a position subsequent to being secured.

FIG. 5 illustrates the alternative embodiment of FIG. 2, as would be seen prior to engagement with the seat belt main buckle receiver.

FIG. 6 illustrates the magnetic buckle receiver engaged and held in place by the alternative embodiment of the seat belt holding strap of FIG. 2.

### 4. DETAILED DESCRIPTION

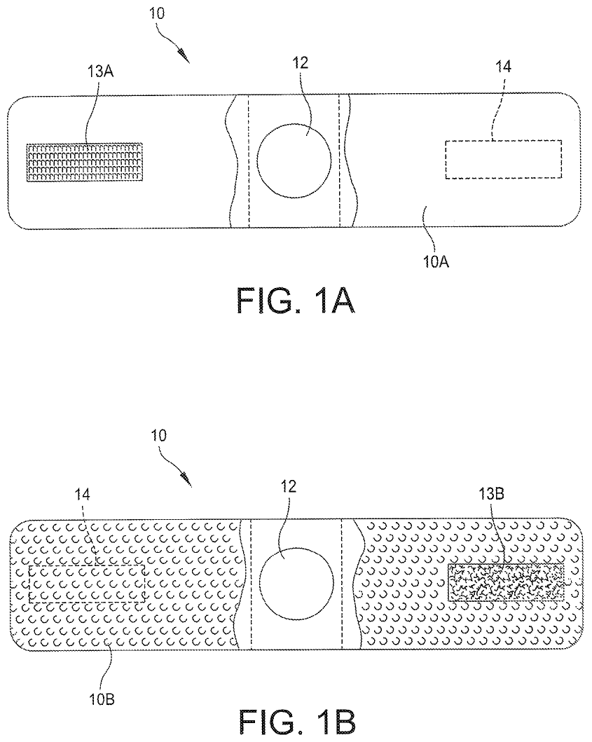

The present invention, while not limited to, discloses a Seat Belt Holding Strap for a child car seat. Referring to FIGS. 1A and 1B, the Holding Strap 10 is generally rectangular and includes an elongated fabric portion. The fabric portion includes a magnet 12 positioned interior to the fabric and located proximally to the middle of the elongated holding strap 10. The magnet 12 is placed interior to the fabric and secured therein by sewing or other means to keep the magnet in the middle position. The top 10A surface of Strap 10 includes a Velcro fabric with the hook portion side 13A at one end of the Strap 10 while the back side 10B includes a Vecro Fabric with the loop side 13B at the opposite end of Strap 10. The back side further includes along the surface non-stick elements 14. These non-stick elements can be placed in any manner known in the art, and in the preferred embodiment the elements are an integral part of the woven fabric that comprises the back side 10B.

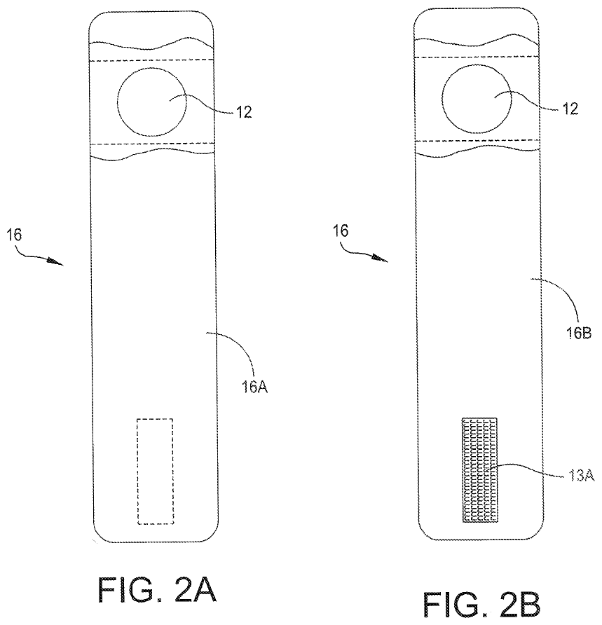

Referring to FIGS. 2A and 2B, an alternative embodiment 16 of the seat belt holding strap 10 is disclosed. The Holding Strap 16 is generally rectangular and includes an elongated fabric portion. The fabric portion includes a magnet 12 positioned interior to the fabric and located at the distal end of the elongated holding strap 16. The magnet 12 is placed interior to the fabric and secured therein by sewing or other means to keep the magnet in the end position.

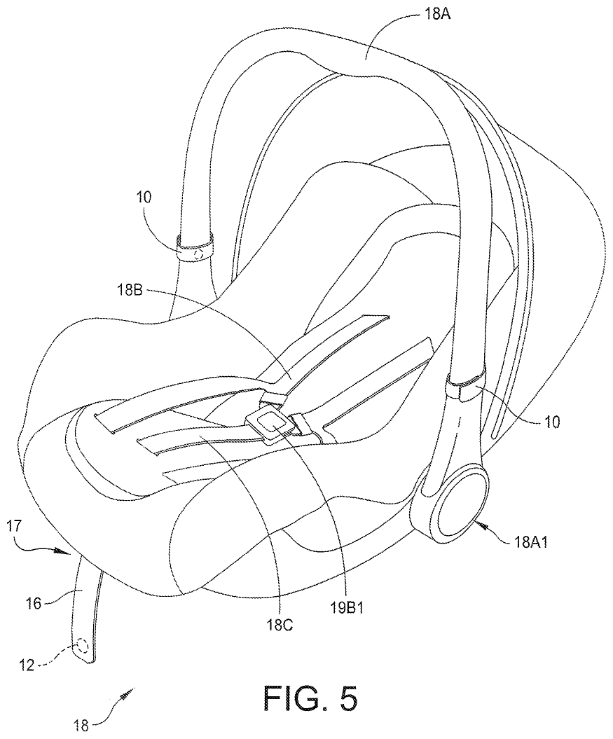

The top 16A surface of Strap 16 may include decorative designs and the bottom surface 16B includes a velcro fastener. The hook/loop configuration of fastening is utilized where the hook material 13A is placed on the bottom 16B of Strap 16. Referring to FIG. 5, the loop material (not shown) is attached to the fabric under the car seat 18 at position 17, for engagement with hook material 13A.

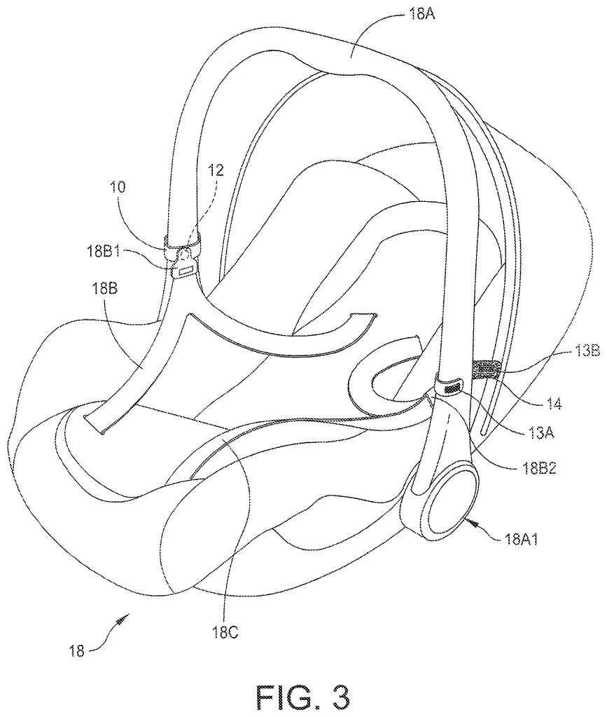

Referring to FIG. 3, holding strap 10 is utilized for securing car seat 18 straps 18B and 18C with metal buckles 18B1 and 18B2 in a position that leaves the interior of car seat open for easy placement of a child therein. In the preferred implementation holding strap 10 backside 10B is wrapped around car seat carrying arm 18A and non-stick elements 14 engage carrying arm to secure holding strap 10 in a static position along carrying arm 18A. The specific location of holding strap 10 is variable along carrying arm 18A. In the preferred embodiment the placement is at the end of carrying arm 18A adjacent to the point where carrying arm 18 attaches to child seat 18 (see point 18A1). In this position child restraints 18B1 and 18B2 are secured to the sides of car seat 18 and create unobstructed space for the placement of a child in the seat.

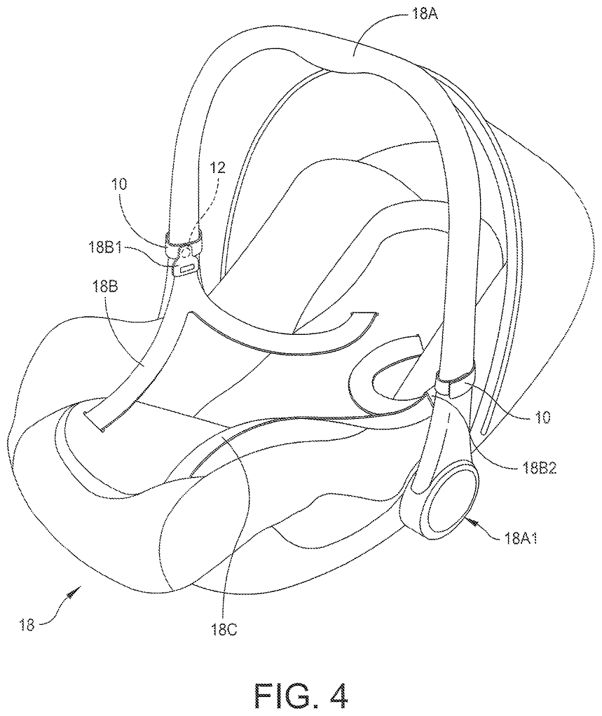

Magnet 12 is placed facing the interior of the seat and the Velcro portions 13A and 13B are secured leaving the strap 18B and 18C secured to the carrying arm 18A. At this point buckles 18B1 and 18B2 are simply put into contact with magnet 12 of holding strap 10 to secure the strap and buckle as illustrated in FIG. 4. At this point obstructions from the child restraints 18B1 and 18B2 are cleared allowing the child to be placed onto the interior of the seat. Once placed, the buckles are removed from the magnet and the restraints are secured into buckle receiver 19B1 as illustrated in FIG. 5.

The strength of the magnet utilized should be such that the buckle will stay in place under normal driving conditions and further such that it will be easy to engage/disengage.

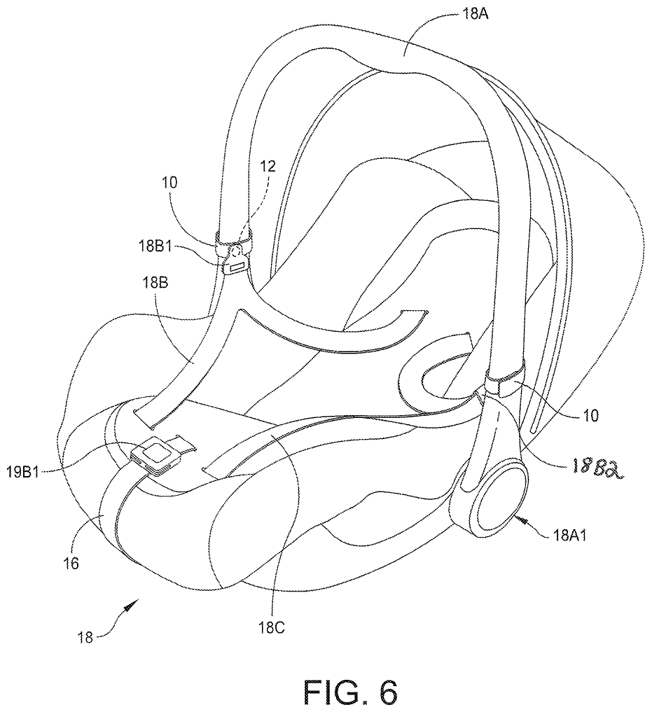

Referring to FIG. 5, an alternative embodiment of the holding strap 10 is illustrated as Holding strap 16. In this embodiment the holding strap 16 is utilized to secure buckle receiver 19B1 to magnet 12 positioned interior to the fabric and located at the distal end of the elongated holding strap 16. This strap allows for buckle receiver 19B1 to be secured away from the interior of the seat 18, thereby allowing for unobstructed placement of a child in car seat 18, as illustrated in FIG. 6.

It should be understood that the foregoing description is only illustrative of the invention. Thus, various alternatives and modifications can be devised by those skilled in the art without departing from the invention. Accordingly, the present invention is intended to embrace all such alternatives, modifications and variances that fall within the scope of the claims in a subsequently filed utility patent application.

I claim:

1. A harness restraint system, the harness restraint system being configured to secure a plurality of harnesses of a child car seat, the harnesses having buckles thereon, the car seat having a left and right arm portion, a bottom portion, and an interior space, the harness restraint system comprising:
a first and second elongated strap with a magnetized portion located in the center of said first and second elongated straps, said straps capable of being joined at their ends to form a wrap at a plurality of points to shorten or lengthen the wrap diameter;
wherein said first and second elongated straps are configured to wrap around said car seat left and right arm portions, being joined at their ends at a point where said magnetic portion of said first and second elongated straps are facing said car seat interior space, and wherein said wrap diameter is sufficient to fix said first and second elongated straps at a static position along said left and right arm portions;
wherein said plurality of straps of the child car seat are secured in the open position when said harness buckles magnetically engage said magnetic portion of said first and second elongated straps, and in the closed position when said harness buckles are disengaged from said magnetic portion of said first and second elongated straps.

2. A harness restraint system of claim 1 wherein said harness restraint system further includes a third elongated strap with a magnetized portion located at said third strap first distal end, said second distal end of said third strap attached to said bottom portion of said car seat, wherein one of said plurality of straps of the child car seat are secured in the open position when said harness buckles magnetically engage said magnetic portion of said third elongated strap, and in the closed position when said harness buckles are disengaged from said magnetic portion of said third elongated strap.

3. A harness restraint system of claim 1 wherein said first and second elongated straps are joined at their ends by a Velcro fastener.

4. A harness restraint system of claim 2 wherein said third elongated strap is joined to said car seat by a Velcro fastener.

5. A harness restraint system of claim 1, wherein said first and second elongated straps have a top and bottom portion, the bottom portion having a non-stick coating material to facilitate the securement of said first and second elongated straps at a static position.

6. A harness restraint system of claim 5, wherein said top portion includes an artistic design.

7. A harness restraint system of claim 2, wherein said third elongated strap has a top and bottom portion, said top portion including an artistic design.

8. A child car seat harness restraint comprising an elongated strap with a magnetized portion located in the center of said strap, said strap capable of being joined at its ends to form a wrap at a plurality of points to shorten or lengthen the wrap diameter.

9. A child car seat harness restraint comprising an elongated strap with a magnetized portion located at the center of said strap, said strap capable of being attached at one end to said car seat.
